(19) United States
(12) Patent Application Publication
(10) Pub. No.: US 2020/0045591 A1
(43) Pub. Date: Feb. 6, 2020

(54) WIRELESS TERMINAL, BASE STATION, WIRELESS COMMUNICATION SYSTEM, AND METHOD

(71) Applicant: FUJITSU LIMITED, Kawasaki-shi (JP)

(72) Inventor: Hitoshi Yokoyama, Shinagawa (JP)

(73) Assignee: FUJITSU LIMITED, Kawasaki-shi (JP)

(21) Appl. No.: 16/601,100

(22) Filed: Oct. 14, 2019

Related U.S. Application Data
(63) Continuation of application No. PCT/JP2017/015472, filed on Apr. 17, 2017.

(51) Int. Cl. H04W 36/00; H04W 76/11; H04W 76/28; H04W 36/08

(52) U.S. Cl. CPC H04W 36/0033; H04W 76/11; H04W 88/085; H04W 36/08; H04W 76/28

(57) ABSTRACT

A wireless terminal includes a radio transceiver configured to transmit or receive a radio signal, a storage configured to store first connection identification information about a communication connection between a core network and a first base station of a plurality of base stations and base station identification information identifying the first base station, a controller configured to perform control to transmit the first connection identification information and the base station identification information via the radio transceiver to a second base station when changing a serving cell or a central unit, and perform control to store, in the storage, second connection identification information for identifying the connection setting information received from the second base station.

### CROSS-REFERENCE TO RELATED APPLICATION

This application is a continuation application of International application PCT/JP2017/015472 filed on Apr. 17, 2017 and designated the U.S., the entire contents of which are incorporated herein by reference.

### FIELD

The present invention relates to, for example, a wireless terminal, a base station, a wireless communication system, and a wireless communication method for performing wireless communication.

### BACKGROUND

In a wireless communication system such as a mobile communication system, a discontinuous reception (DRX) function is adopted to reduce the power consumption of a wireless terminal. For example, in LTE (Long Term Evolution), which is one of the wireless communication standards for mobile communication, a wireless terminal wakes up (or changes into an operation state, or changes into a standby state) in a time interval (for example, a subframe) for each cycle (i.e., DRX cycle) that is set in advance for each wireless terminal. The wireless terminal demodulates and decodes the transmitted wireless resource allocation information (scheduling information) during the wake-up time interval. Then, the wireless terminal refers to the scheduling information and checks whether there is an incoming call addressed to the wireless terminal based on the presence of resources assigned to the wireless terminal. On the other hand, the wireless terminal reduces the power consumption by turning off the operation of the units that perform such demodulation processing and decoding processing in the connections that perform wireless communication processing outside of the wake-up time interval.

In addition, in studies of the specifications of the so-called 5th generation mobile communication system by the 3GPP working group, it has been suggested to add an Inactive state as one of the Radio Resource Control (RRC) states so as to be able to accommodate sleeping for a period of time longer than DRX. It should be noted that the fifth generation mobile communication system is a standard for mobile communication newer than LTE and LTE-Advanced.

In the RRC Inactive state, a connection in the core network (hereinafter referred to as a host network) established between the base station and a host node is maintained (set) without being disconnected even during the period in which the wireless terminal stops communication. On the other hand, a radio connection between the base station and the wireless terminal is disconnected (for example, see Non-Patent Document 1). It should be noted that a state in which both of the host connection and the radio connection are connected (set) is referred to as an RRC connected state (or an RRC Connected), and a state in which both of the host connection and the radio connection are disconnected is referred to as an RRC Idle state (or Idle, standby). The RRC Inactive state may be interpreted as a state in-between the RRC Connected state and the RRC Idle state.

A resume function has been suggested. With the resume function, connection setting information with which a wireless terminal communicates via a base station is stored in the RRC Inactive state, and when the wireless terminal resumes communication, the wireless terminal uses the stored connection setting information, so that some of the communications of control information can be omitted when resuming the communication. With regard to the resume function, for example, the stored connection setting information is managed in association with identification information (hereinafter referred to as a resume ID). Therefore, when the wireless terminal resumes the communication, a resume ID is transmitted between the wireless terminal and the base station, and the wireless terminal and the base station use the connection setting information corresponding to the same resume ID, so that the wireless terminal can resume the communication. Also, by using this connection setting information and the resume ID, the amount of communication of control information for resuming the communication is reduced.

Therefore, by introducing the RRC Inactive state, it is expected to reduce the power consumption of devices that communicate, for example, once a day or with a lower frequency, such as, e.g., wireless terminals used for so-called Internet of Things (IoT).

However, there may be a situation where it is preferable to change a serving cell from which the wireless terminal waits for radio signals addressed to the wireless terminal during a period in which the wireless terminal is in the RRC Inactive state to stop communication. Hereinafter, a cell from which the wireless terminal waits for radio signals addressed to the wireless terminal will be simply referred to as a serving cell (which may also be referred to as a camped-on cell). Even in such a case, it is preferable that the connection setting information maintained for the wireless terminal is transferred to another base station that provides a serving cell to which the wireless terminal changes to camp on.

### RELATED-ART DOCUMENTS

### Non-Patent Document

Non-Patent Document 1: Tdoc R2-166059, Sierra Wireless, Transmission of Data Grant-Free in New State, 3GPP TSG-RAN WG2 #95bis, Kaohsiung, Taiwan, Oct. 10-14, 2016

### SUMMARY

According to one aspect of an embodiment, a wireless terminal includes:

a radio transceiver configured to transmit a radio signal to any one of a plurality of base stations providing cells, or to receive a radio signal from any one of the plurality of base stations;

a storage configured to store first connection identification information and base station identification information, the first connection identification information identifying connection setting information, in a first state, about a communication connection between a core network and a first base station of the plurality of base stations used by the wireless terminal to communicate via the first base station, the base station identification information identifying the first base station, the first base station providing a first cell adopted as a serving cell which the wireless terminal camps on for the radio signal, and the first state being a state in which a radio connection between the wireless terminal and the first base station is disconnected but the communication connection is maintained; and

a controller configured to perform control to transmit the first connection identification information and the base station identification information via the radio transceiver to a second base station providing a second cell when changing the serving cell or a central unit while the wireless terminal is in the first state, the central unit processing the radio signal, and perform control to store, in the storage, second connection identification information for identifying the connection setting information received from the second base station.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a schematic configuration diagram of a wireless communication system according to an embodiment;

FIG. 2 is a sequence diagram illustrating processing for transfer of connection setting information according to an example;

FIG. 3 is a schematic configuration diagram illustrating a base station;

FIG. 4 is an operation flowchart performed by a target base station in transfer processing of connection setting information;

FIG. 5 is an operation flowchart performed by a source base station in the transfer processing of the connection setting information;

FIG. 6 is a schematic configuration diagram illustrating a wireless terminal;

FIG. 7 is an operation flowchart performed by a wireless terminal in the transfer processing of the connection setting information;

FIG. 8 is a schematic configuration diagram illustrating a wireless communication system according to a variation;

FIG. 9 is a sequence diagram of processing for transfer of the connection setting information according to the variation;

FIG. 10 is a schematic configuration diagram illustrating a central unit;

FIG. 11 is a schematic configuration diagram illustrating a distributed unit;

FIG. 12 is an operation flowchart performed by a wireless terminal in transfer processing of connection setting information according to the variation;

FIG. 13 is a sequence diagram of processing for transfer of connection setting information according to another variation;

FIG. 14 is an operation flowchart performed by a target central unit in the transfer processing of the connection setting information according to the another variation; and

FIG. 15 is an operation flowchart performed by a wireless terminal in the transfer processing of the connection setting information according to the another variation.

### DESCRIPTION OF EMBODIMENT

A wireless communication system, and a base station and a wireless terminal used in the wireless communication system, and a wireless communication method will be explained with reference to drawings. This wireless communication system supports resume function, and manages connection setting information maintained by the resume function by attaching a resume ID serving as identification information of the connection setting information. Then, in a case where the wireless terminal changes the serving cell while the wireless terminal is in RRC Inactive state, the wireless terminal notifies identification information about a source base station providing an old serving cell and a resume ID to a target base station providing a new serving cell. When the target base station receives the resume ID and the identification information about the source base station from the wireless terminal, the target base station notifies the resume ID to the source base station, and receives the connection setting information corresponding to the resume ID from the source base station. Then, the target base station uses the received connection setting information to establish a host connection for the wireless terminal, and assigns a resume ID to the wireless terminal, and notifies the assigned resume ID to the wireless terminal. Therefore, even when the serving cell of the wireless terminal is changed while the wireless terminal stops the communication, the wireless communication system can transfer the connection setting information maintained for the wireless terminal from the source base station to the target base station.

It should be noted that the connection setting information includes, for example, information about Authentication, Security, and Context. The information about Authentication includes, for example, information about whether SIM information about the wireless terminal is authenticated or not. The information about Security includes, for example, information about encryption setting used for data communication with the wireless terminal. The information about Context includes, for example, information about setting of Quality of Service (QoS).

In the present application, Node B, eNode B, gNode B, access point, or the like are examples of base stations. Further, a mobile station, a mobile terminal, or User Equipment (UE) are examples of wireless terminals.

In the present application, “two elements are connected” not only means that two elements are directly, electrically connected by a wire or the like, but also includes a case where two elements are indirectly connected to allow communication therebetween via a medium such as electric signals, radio waves, or light by way of other devices such as a transceiver, a conversion device, or the like.

In the present application, when the wireless terminal changes the serving cell to another cell, the serving cell which the wireless terminal camps on before the change will be referred to as an old serving cell, and the another serving cell which the wireless terminal camps on after the change will be referred to as a new serving cell.

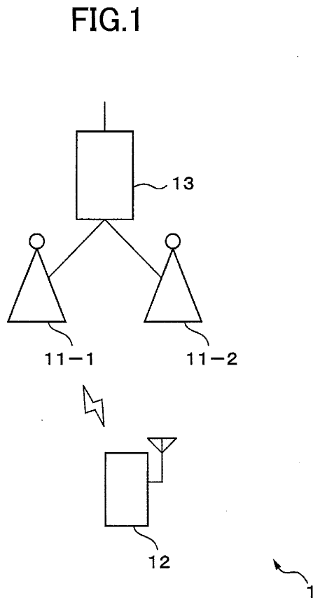

FIG. 1 is a schematic configuration diagram of a wireless communication system according to an embodiment. The wireless communication system 1 includes two base stations 11-1, 11-2, a wireless terminal 12, and a host node 13. Then, the base stations 11-1, 11-2 and the wireless terminal 12 transmit signals with each other by wireless communication. The number of base stations included in the wireless communication system 1 is not limited to two, and the wireless communication system 1 may include three or more base stations. Likewise, the wireless communication system 1 may include multiple wireless terminals 12, or may include multiple host nodes 13. In a case where the wireless communication system 1 includes multiple host nodes 13, a host node to which the base station 11-1 is connected may be different from a host node to which the base station 11-2 is connected. Further, the wireless terminal 12 may be a mobile terminal, or may be a fixed communication apparatus.

The base station 11-1 and the base station 11-2 relay communication between the wireless terminal 12 and the host node 13. Therefore, the base station 11-1 and the base station 11-2 are connected to the host node 13 according to a predetermined communication standard, such as, e.g., S1 interface, stipulated for communication between the host node 13 and the base station. The base station 11-1 and the base station 11-2 may be connected with each other or may be connected with another base station according to a predetermined communication standard, such as, e.g., X2 interface, stipulated for communication between the base stations.

Each of the base station 11-1 and the base station 11-2 provides one or more cells. For example, in a case where the wireless terminal 12 camps on any given cell that is set by the base station 11-1, the wireless terminal 12 can perform wireless communication with the base station 11-1. Then, the base station 11-1 executes a procedure for setting a wireless communication, such as, e.g., random access procedure and context setup, with the wireless terminal 12 capable of wireless communication, and executes a procedure for setting a host connection. Thereafter, the base station 11-1 receives a communication signal addressed to the wireless terminal 12 from the host node 13, and transmits the communication signal as a downlink radio signal to the wireless terminal 12. Also, the base station 11-1 receives an uplink radio signal from the wireless terminal 12, retrieves a communication signal to another communication apparatus (not illustrated) included in the radio signal, and transmits a communication signal to the host node 13. Likewise, in a case where the wireless terminal 12 is camping on any given cell that is set by the base station 11-2, the base station 11-2 transmits a downlink radio signal to the wireless terminal 12, or receives an uplink radio signal from the wireless terminal 12.

In a case where the wireless terminal 12 is camping on any given cell that is set by the base station 11-1, and the base station 11-1 is a source base station, the base station 11-1 executes processing for setting resume while the wireless terminal 12 is in RRC connected state. More specifically, the base station 11-1 attaches a resume ID to the connection setting information for the wireless terminal 12 so that the wireless terminal 12 can use the resume function. Then, the base station 11-1 stores connection setting information together with the corresponding resume ID. Further, while the wireless terminal 12 is continuing wireless communication with the base station 11-1, i.e., while the wireless terminal 12 is in the RRC Connected state, the base station 11-1 notifies the resume ID to the wireless terminal 12. Likewise, in a case where the wireless terminal 12 is camping on any given cell that is set by the base station 11-2, and the base station 11-2 serves as a source base station, the base station 11-2 attaches a resume ID to the connection setting information for the wireless terminal 12. Then, the base station 11-2 stores the connection setting information together with the corresponding resume ID. Further, while the wireless terminal 12 is in the RRC Connected state, the base station 11-2 notifies the resume ID to the wireless terminal 12.

Thereafter, in a case where the wireless terminal 12 determines to change the serving cell, the base station 11-1 and the base station 11-2 execute processing for transfer of the connection setting information. It should be noted that the details of the processing for the transfer of the connection setting information will be explained later.

The wireless terminal 12 is a wireless terminal capable of using the resume function, and for example, after the host connection and the radio connection have been set in the RRC Connected state, the wireless terminal 12 changes into RRC Inactive state to stop communication. More specifically, even when the radio connection between the wireless terminal 12 and the base station 11-1 or the base station 11-2 is disconnected, the host connection for the wireless terminal 12 is maintained. The connection setting information for the wireless terminal 12 is maintained and managed in the base station 11-1 or the base station 11-2. Then, with a certain cycle (for example, several hours, several days, one month, and the like) or when a specific event occurs, the wireless terminal 12 reconnects the radio connection, and resumes communication with another communication apparatus (not illustrated) by using the held connection setting information.

The host node 13 includes, for example, Serving Gateway (S-GW), Mobility Management Entity (MME), and Packet data network Gateway (P-GW), and controls the base station 11-1 or the base station 11-2 or establishes a connection in the core network that performs data communication. The host node 13 executes location registration of the wireless terminal 12 and control for hand over between base stations, and executes control of QoS and control of billing and the like. Also, the host node 13 executes control of the host connection such as establishment or deletion of bearers.

Hereinafter, the details of processing for transfer of the connection setting information will be explained. For example, the transfer of the connection setting information is executed in a case where the wireless quality of another cell is better than the wireless quality of the old serving cell for the wireless terminal 12.

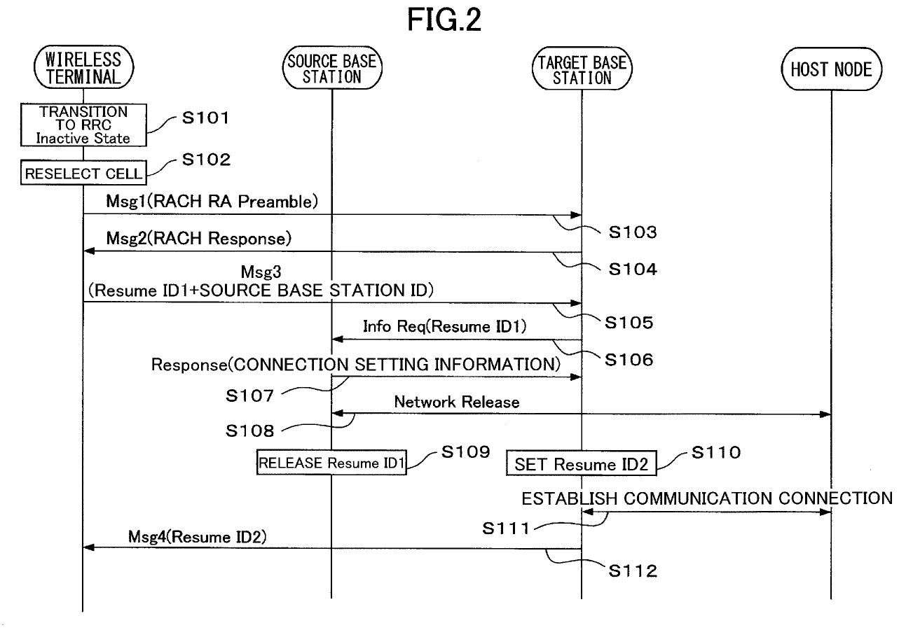

FIG. 2 is a sequence diagram illustrating processing for transfer of the connection setting information according to an example. In this example, in the hand over, the base station 11-1 is assumed to be a source base station, and the base station 11-2 is assumed to be a target base station. Also, a resume ID which the base station 11-1 assigns to the connection setting information for the wireless terminal 12 is denoted as a resume ID1, and a resume ID which the base station 11-2 assigns to the connection setting information for the wireless terminal 12 is denoted as a resume ID2.

The connection setting for the wireless terminal 12 is performed while the wireless terminal 12 is in the RRC connected state, and after the resume ID1 is assigned to the connection setting information, the wireless terminal 12 changes into RRC Inactive state (step S101).

After the wireless terminal 12 changes into the RRC Inactive state, the wireless terminal 12 measures, with a certain cycle or irregularly, the wireless quality of the old serving cell that is set by the base station 11-1 and the wireless quality of the cell that is set by the base station 11-2. Then, in a case where the wireless quality of the cell that is set by the base station 11-2 is determined to be better than the wireless quality of the old serving cell, the wireless terminal 12 determines to reselect a serving cell (step S102). Then, the wireless terminal 12 changes the serving cell from the cell provided by the base station 11-1 to the cell provided by the base station 11-2.

When the wireless terminal 12 determines to reselect a serving cell, the wireless terminal 12 executes random access procedure for the base station 11-2 which is the target base station. More specifically, the wireless terminal 12 refers to the identification information about the base station 11-2 indicated by the broadcast information from the base station 11-2. Then, the wireless terminal 12 uses a wireless resource for physical random access (i.e., Physical Random Access Channel, PRACH) indicated by the broadcast information to transmit a Message 1 including a RA preamble to the base station 11-2 (step S103). When the base station 11-2 detects the RA preamble, the base station 11-2 transmits an RA response, i.e., response information for the RA preamble, as a Message 2 to the wireless terminal 12 (step S104). It should be noted that the RA response includes Timing Advance (TA) information for adjusting timing with which the wireless terminal 12 transmits uplink signals. The wireless terminal 12 establishes precise synchronization in terms of time with the base station 11-2 by referring to the TA information. Then, the wireless terminal 12 receives an uplink (UL) scheduling grant from the base station 11-2. The UL scheduling grant includes information indicating resource block for uplink assigned to the wireless terminal 12 and the like.

The wireless terminal 12 transmits a connection request signal (Radio Resource Control Connection Request), the resume ID1, and the identification information about the base station 11-1, i.e., the source base station, as a Message 3 to the base station 11-2 on the basis of the UL scheduling grant (step S105). It should be noted that identification information about a cell provided by the base station (an ID of a cell) is an example of identification information about the base station.

When the base station 11-2 receives the Message 3 including the resume ID1 and the identification information about the base station 11-1, the base station 11-2 refers to the identification information about the base station 11-1, and transmits the resume ID1 to the base station 11-1 to query the connection setting information for the wireless terminal 12 (step S106). In a case where the base station 11-1 and the base station 11-2 are connected with each other via X2 interface, the base station 11-2 directly transmits the resume ID1 to the base station 11-1 without going through the host node 13. In a case where the base station 11-1 and the base station 11-2 are connected to different host nodes, the base station 11-2 transmits the resume ID1 to the base station 11-1 via the host nodes.

When the base station 11-1 receives the resume ID1 assigned to the wireless terminal 12 from the base station 11-2, the base station 11-1 replies with the connection setting information for the wireless terminal 12, stored in association with the resume ID1, to the base station 11-2 (step S107). At this occasion, in a case where the base station 11-1 and the base station 11-2 are connected with each other via X2 interface, the base station 11-1 may directly transmit the connection setting information to the base station 11-2 without going through the host node 13. On the other hand, in a case where the base station 11-1 and the base station 11-2 are connected to different host nodes, the base station 11-1 transmits the connection setting information to the base station 11-2 via the host nodes.

Also, the base station 11-1 executes processing for releasing the host connection that is set for the wireless terminal 12 with the host node 13 (step S108). Further, the base station 11-1 also releases (i.e., deletes) the resume ID1 assigned to the wireless terminal 12 (step S109).

On the other hand, when the base station 11-2 receives the connection setting information for the wireless terminal 12 from the base station 11-1, the base station 11-2 assigns the resume ID2 to the wireless terminal 12 (step S110). Then, the base station 11-2 stores the resume ID2 together with the connection setting information for the wireless terminal 12. Also, the base station 11-2 sets the host connection for the wireless terminal 12 on the basis of the connection setting information for the wireless terminal (step S111). More specifically, the base station 11-2 establishes a connection in the core network with the host node 13 for the wireless terminal 12. Then, the base station 11-2 transmits a Message 4 of random access procedure including the resume ID2 to the wireless terminal 12 (step S112). The wireless terminal 12 stores the received resume ID2. Then, the base station 11-1, the base station 11-2, and the wireless terminal 12 finish the transfer processing of the connection setting information.

Thereafter, when the wireless terminal 12 resumes communication, the wireless terminal 12 transmits the resume ID2 to the base station 11-2, and the base station 11-2 may use the connection setting information corresponding to the resume ID2 to resume communication between the wireless terminal 12 and the core network.

Hereinafter, the details of the base station 11-1, the base station 11-2, and the wireless terminal 12 will be explained. It should be noted that the configurations and the functions of the base station 11-1 may be the same as or similar to the configurations and the functions of the base station 11-2, and accordingly, the base station 11-1 will be hereinafter explained.

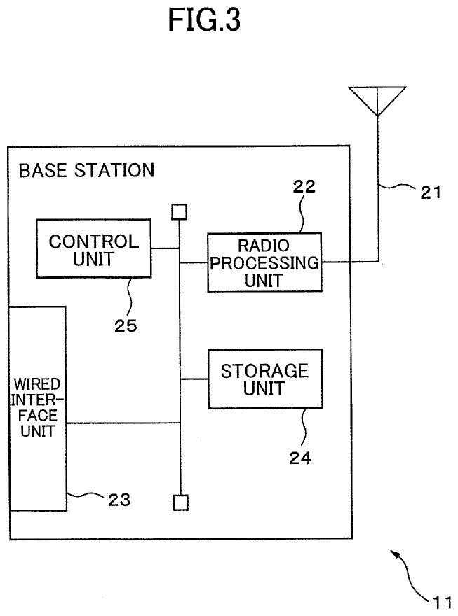

FIG. 3 is a schematic configuration diagram illustrating the base station 11-1. The base station 11-1 includes an antenna 21, a radio processing unit 22, a wired interface unit 23, a storage unit 24, and a control unit 25. The radio processing unit 22, the storage unit 24, and the control unit 25 are formed as separate connections. Alternatively, each of these units may be implemented on the base station 11-1 as one or more integrated connections in which connections corresponding to the respective units are integrated.

In transmission, the antenna 21 transmits as a radio signal a downlink signal transmitted from the radio processing unit 22. In reception, the antenna 21 receives a radio signal including an uplink signal from the wireless terminal 12 and converts it into an electrical signal, and transmits the electrical signal to the radio processing unit 22 as the uplink signal. The antenna 21 may have a transmitting antenna and a receiving antenna separately.

In transmission, the radio processing unit 22 converts the downlink signal received from the control unit 25 into an analog signal and then superimposes the analog signal on a carrier wave having a radio frequency specified by the control unit 25. The radio processing unit 22 amplifies the downlink signal superimposed on the carrier wave to a desired level by a high power amplifier (not illustrated), and transmits the downlink signal to the antenna 21.

In reception, the radio processing unit 22 amplifies the uplink signal received from the antenna 21 by a low noise amplifier (not illustrated). The radio processing unit 22 converts the frequency of the uplink signal from a radio frequency to a baseband frequency by multiplying the amplified uplink signal by a cyclic signal having an intermediate frequency. The radio processing unit 22 performs analog-to-digital conversion on the uplink signal having the baseband frequency, and then passes it to the control unit 25.

The wired interface unit 23 is an example of a communication interface unit, and has a communication interface connection for connecting the base station 11-1 to the host node 13 and other base stations. In reception, the wired interface unit 23 analyzes the signal received from the host node 13 according to S1 interface which is a protocol between the host node and the base station, and extracts the downlink signal and control signal included in the signal. Also, the wired interface unit 23 analyzes signals received from other base stations according to X2 interface protocol between neighboring base stations, and extracts the control signal, the connection setting information, or the resume ID included in the signal. Then, the wired interface unit 23 passes the extracted downlink signal and the control signal to the control unit 25.

In transmission, the wired interface unit 23 converts the uplink signal received from the control unit 25 into a signal in the format according to S1 interface and outputs the signal to the host node 13. Also, the wired interface unit 23 converts the control signal, the connection setting information, or the resume ID to be sent to another base station into a format according to the X2 interface. The wired interface unit 23 outputs (or transmits or notifies) the control signal to another base station.

The storage unit 24 has, for example, a rewritable nonvolatile semiconductor memory or a volatile semiconductor memory. The storage unit 24 stores various information for communicating with the wireless terminal 12 (including the identification information about the base station 11-1), various information transmitted and received by the base station 11-1, and various programs operating on the base station 11-1. Furthermore, the storage unit 24 stores information about the resume function for a wireless terminal connected to the base station 11-1, i.e., the connection setting information and the resume ID.

In transmission, the control unit 25 has, for example, one or more processors and their peripheral connections. The control unit 25 modulates and multiplexes the downlink signal according to the modulation and multiplexing scheme adopted in the communication standard with which the wireless communication system 1 complies. The control unit 25 then passes the modulated and multiplexed downlink signal to the radio processing unit 22. For example, the control unit 25 modulates and multiplexes the downlink signal according to F-OFDM.

In reception, the control unit 25 separates the uplink signal received from the radio processing unit 22 according to the modulation and multiplexing scheme adopted in the communication standard with which the wireless communication system 1 complies, and demodulates the separated received signal. For example, the control unit 25 separates and demodulates the uplink signal according to F-OFDM. Then, the control unit 25 outputs the demodulated uplink signal to the wired interface unit 23. Further, the control unit 25 extracts various signals referred to by the base station 11-1, control information for the call control, communication quality measurement information at the wireless terminal 12, and the like from the demodulated uplink signal.

In addition, the control unit 25 executes various kinds of processing for executing wireless communication such as transmission power control and call control. Furthermore, the control unit 25 attaches the resume ID to the connection setting information obtained by performing connection setting processing for the wireless terminal 12.

Furthermore, in a case where the base station 11-1, serving as the target base station for the wireless terminal 12, takes over the connection setting information from another base station (for example, the base station 11-2), the control unit 25 executes processing of the target base station in the transfer processing of the connection setting information. On the other hand, in a case where the base station 11-1, serving as the source base station for the wireless terminal 12, passes the connection setting information to another base station (for example, the base station 11-2), the control unit 25 executes processing of the source base station in the transfer processing of the connection setting information.

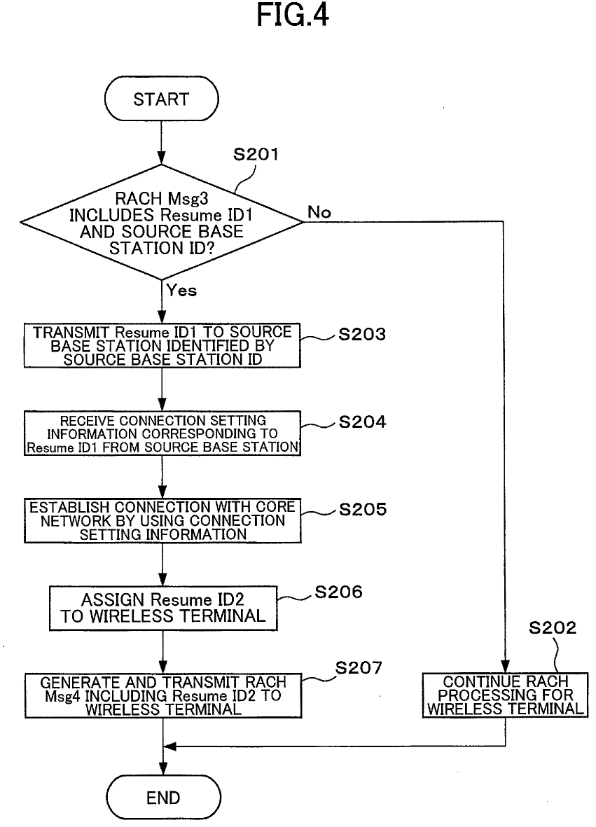

FIG. 4 is an operation flowchart performed by a target base station in the transfer processing of the connection setting information.

The control unit 25 determines whether a Message 3 of the random access procedure received from the wireless terminal 12 includes the resume ID1 assigned to the wireless terminal 12 by the source base station and the identification information about the source base station (step S201). In a case where the resume ID1 and the identification information about the source base station are not included (step S201-No), the control unit 25 continues the processing of the random access procedure for the wireless terminal 12 (step S202).

On the other hand, in a case where the resume ID1 and the identification information about the source base station are included (step S201-Yes), the control unit 25 transmits the resume ID1 to the source base station identified by the identification information about the source base station via the wired interface unit 23 (step S203). As a result, the control unit 25 queries the source base station for connection setting information corresponding to resume ID1. Then, the control unit 25 receives the connection setting information corresponding to the resume ID1 from the source base station via the wired interface unit 23 (step S204).

When the control unit 25 receives the connection setting information, the control unit 25 establishes a connection in the core network (i.e., a host connection) between the host node 13 and the base station 11-1 for the wireless terminal 12 by using the connection setting information (step S205). Further, the control unit 25 assigns a resume ID2 to the wireless terminal 12, and stores, into the storage unit 24, the resume ID2 together with the received connection setting information (step S206).

The control unit 25 generates a Message 4 of random access procedure including the resume ID2, and transmits the Message 4 to the wireless terminal 12 as a wireless radio wave via the radio processing unit 22 and the antenna 21 (step S207). After step S202 or step S207, the control unit 25 ends the operation of the target base station in the transfer processing of the connection setting information. It should be noted that the control unit 25 may interchange the order of processing in step S205 and processing in step S206, or may execute the processing in step S205 and the processing in step S206 in parallel.

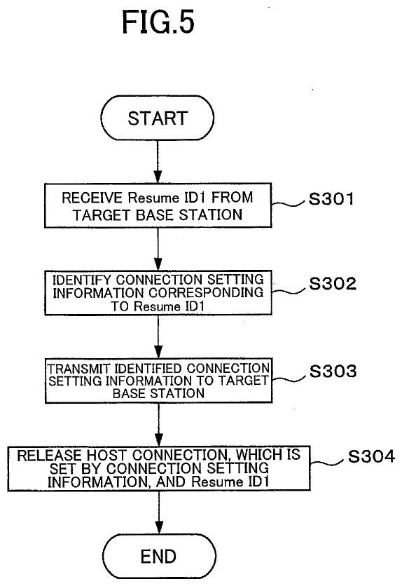

FIG. 5 is an operation flowchart performed by the source base station in the transfer processing of the connection setting information. The control unit 25 receives the resume ID1 from the target base station via the wired interface unit 23 (step S301). The control unit 25 refers to the storage unit 24 and identifies connection setting information corresponding to the received resume ID1 (step S302).

Then, the control unit 25 transmits the identified connection setting information to the target base station via the wired interface unit 23 (step S303). In addition, the control unit 25 releases the communication connection (i.e., the host connection) between the base station 11-1 and the core network for the wireless terminal 12, which is set by the connection setting information corresponding to the resume ID1, and releases (i.e., deletes) the resume ID1 (step S304). Then, the control unit 25 finishes the operation of the source base station in the transfer processing of the connection setting information.

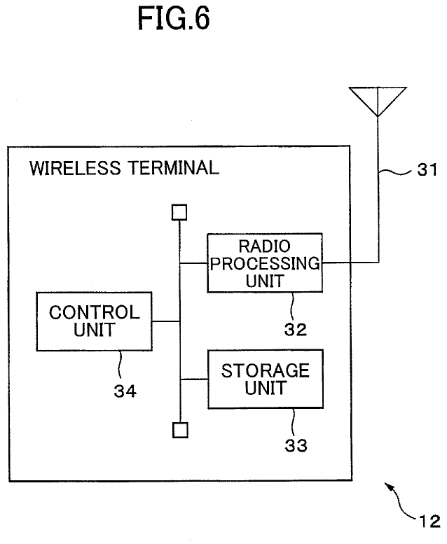

FIG. 6 is a schematic configuration diagram illustrating the wireless terminal 12. The wireless terminal 12 includes an antenna 31, a radio processing unit 32, a storage unit 33, and a control unit 34. Further, the wireless terminal 12 may include at least one of a user interface (not illustrated) such as a touch panel, a microphone (not illustrated), a speaker (not illustrated), and a camera (not illustrated). Furthermore, the wireless terminal 12 may have a Global Positioning System (GPS) receiver (not illustrated) in order to measure the position of the wireless terminal 12. The radio processing unit 32, the storage unit 33, and the control unit 34 are formed as separate connections. Alternatively, each of these units may be implemented on the wireless terminal 12 as one or more integrated connections in which connections corresponding to the respective units are integrated.

The antenna 31 transmits the uplink signal transmitted via the radio processing unit 32 as a radio signal. The antenna 31 receives a radio signal from the base station 11-1 or the base station 11-2, converts it into an electrical signal as a downlink signal, and transmits the downlink signal to the radio processing unit 32. The antenna 31 may have a transmitting antenna and a receiving antenna separately.

In transmission, the radio processing unit 32 converts the uplink signal received from the control unit 34 into an analog signal, and then superimposes the analog signal on a carrier wave having a radio frequency specified by the control unit 34. The radio processing unit 32 amplifies the uplink signal superimposed on the carrier wave to a desired level by a high power amplifier (not illustrated), and transmits the uplink signal to the antenna 31.

In reception, the radio processing unit 32 amplifies the downlink signal received from the antenna 31 by a low noise amplifier (not illustrated). The radio processing unit 32 converts the frequency of the downlink signal from the radio frequency to a baseband frequency by multiplying the amplified downlink signal by a cyclic signal having an intermediate frequency. The radio processing unit 32 performs analog-to-digital conversion on the downlink signal having the baseband frequency and then passes it to the control unit 34.

The storage unit 33 has, for example, a rewritable nonvolatile semiconductor memory or a volatile semiconductor memory. The storage unit 33 has various information for communicating with the base station 11-1 or the base station 11-2 (for example, the identification information about a base station from which the wireless terminal 12 can receive radio signals), and various data that is transmitted and received by the wireless terminal 12. The storage unit 33 stores various programs operating on the wireless terminal 12. Furthermore, the storage unit 33 stores information about the resume function, i.e., resume IDs.

The control unit 34 has, for example, one or more processors and their peripheral connections. In transmission, the control unit 34 modulates and multiplexes the uplink signal according to the modulation and multiplexing scheme adopted in the communication standard with which the wireless communication system 1 complies. The control unit 34 then passes the modulated and multiplexed uplink signal to the radio processing unit 32. For example, the control unit 34 modulates and multiplexes the uplink signal according to a multiplexing scheme based on F-OFDMA.

In reception, the control unit 34 separates the downlink signal received from the radio processing unit 32 according to the modulation and multiplexing scheme adopted in the communication standard with which the wireless communication system 1 complies, and demodulates the separated received signal. For example, the control unit 34 separates and demodulates the downlink signal according to F-OFDM. Then, the control unit 34 performs processing according to the retrieved control information or data. For example, in a case where the downlink signal includes an audio signal, the control unit 34 reproduces the audio signal through a speaker (not illustrated). In addition, in a case where the downlink signal includes a video signal, the control unit 34 plays the video signal on a touch panel (not illustrated).

In addition, the control unit 34 executes various processing for executing wireless communication with the base station 11-1 or the base station 11-2, such as connection request processing. Also, for each of the cells in which the wireless terminal 12 is located, the control unit 34 measures, with a certain cycle or irregularly, the wireless quality of radio signal received from the cell via the antenna 31 and the radio processing unit 32. At that occasion, the control unit 34 measures, for example, a power, a signal-to-noise ratio, or a signal-to-interference noise ratio of the received radio signal as the quality of radio signal.

In addition, the control unit 34 determines whether to change the serving cell by comparing the quality of radio signal for each cell in which the wireless terminal 12 is located. For example, in a case where the quality of radio signal of another cell is better than the quality of radio signal of the old serving cell, the control unit 34 determines to change the serving cell.

In addition, the control unit 34 executes processing for the resume function, for example, processing for transition from the RRC Connected state to the RRC Inactive state or vice versa, and processing for resuming communication when the wireless terminal 12 is in the RRC Inactive state. Also, when the serving cell is to be changed when the wireless terminal 12 is in the RRC Inactive state, the control unit 34 executes processing for transfer of the connection setting information.

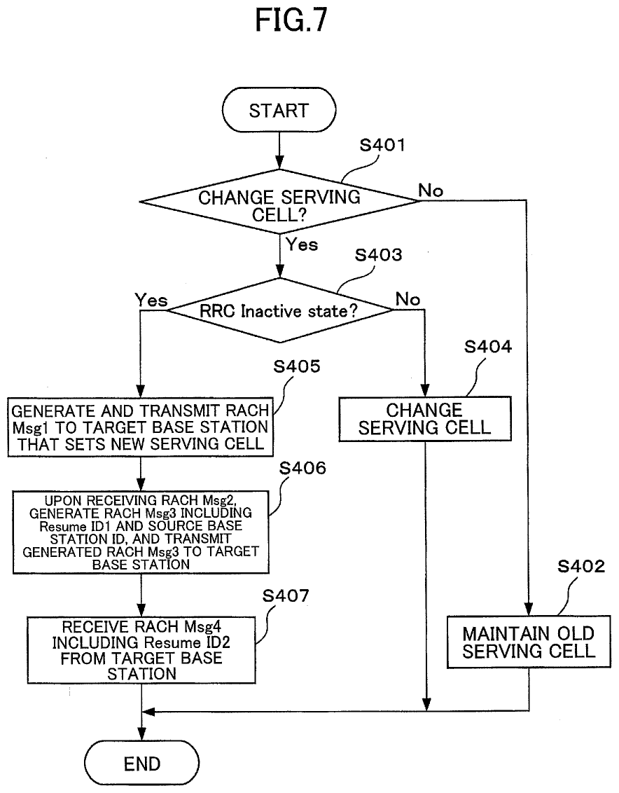

FIG. 7 is an operation flowchart performed by the wireless terminal 12 in the transfer processing of the connection setting information.

The control unit 34 compares the quality of radio signal of the old serving cell and the qualities of the radio signals of other cells in which the wireless terminal 12 is located, and determines whether to change the serving cell (step S401). When the control unit 34 determines not to change the serving cell (step S401-No), the control unit 34 maintains the old serving cell (step S402).

On the other hand, in a case where the control unit 34 determines to change the serving cell (step S401-Yes), the control unit 34 determines whether the wireless terminal 12 is in the RRC inactive state (step S403). In a case where the wireless terminal 12 is not in the RRC Inactive state (step S403-No), the control unit 34 changes the serving cell to another cell of which the quality of radio signal is better than the quality of radio signal of the old serving cell (step S404).

On the other hand, in a case where the wireless terminal 12 is in the RRC Inactive state (step S403-Yes), the control unit 34 generates a Message 1 of the random access procedure including an RA preamble. Then, the control unit 34 refers to the broadcast information transmitted from the new serving cell, and transmits the Message 1 through PRACH to the target base station, which provides the new serving cell, via the radio processing unit 32 and the antenna 31 (step S405).

Thereafter, when the control unit 34 receives a Message 2 of random access procedure from the target base station via the antenna 31 and the radio processing unit 32, the control unit 34 generates a Message 3 of random access procedure including the resume ID1 and the identification information about the source base station. Then, the control unit 34 transmits the Message 3 to the target base station via the radio processing unit 32 and the antenna 31 (step S406).

Thereafter, when the control unit 34 receives a Message 4 of random access procedure from the target base station via the antenna 31 and the radio processing unit 32, the control unit 34 retrieves the resume ID2 included in the Message 4. Then, the control unit 34 saves the resume ID2 in the storage unit 33 (step S407).

After step S402, S404, or S407, the control unit 34 finishes the operation of the wireless terminal 12 in the transfer processing of the connection setting information.

As explained above, when the wireless terminal in the RRC Inactive state changes the serving cell, the wireless terminal transmits the identification information about the source base station providing the old serving cell and the resume ID to the target base station providing the new serving cell. The target base station refers to the identification information about the source base station, and transmits the resume ID to the source base station to query the connection setting information corresponding to the resume ID. Also, when the target base station receives the connection setting information from the source base station, the target base station uses the connection setting information to establish a communication connection with the core network for the wireless terminal, and assigns a resume ID to the wireless terminal. Then, the target base station associates and stores the assigned resume ID and the connection setting information, and notifies the assigned resume ID to the wireless terminal. Therefore, even in a case where the serving cell is to be changed during a period in which the wireless terminal is in the RRC Inactive state to stop the communication, the wireless communication system can transfer the connection setting information maintained for the wireless terminal to the target base station providing the new serving cell. Therefore, this wireless communication system can change the serving cell and maintain the communication connection between the base station and the core network without causing the wireless terminal to once return back to the RRC Connected state. As a result, this wireless communication system can reduce the power consumption of the wireless terminal by reducing the number of times signaling is made when the serving cell is changed.

According to a variation, in the transfer processing of the connection setting information, the wireless terminal may transmit the identification information about the source base station and the resume ID1 to the target base station after the random access procedure is finished. Also, the target base station may notify the resume ID2 to the wireless terminal after the random access procedure is finished.

According to another variation, the base station may be formed according to architecture divided into a central unit (CU) performing processing of radio signals and a distributed unit (DU) transmitting or receiving radio signals. Then, the identification information about a cell may be assigned for each DU. Further, for each CU, a RAN area including DUs connected to the CU may be set, and identification information (i.e., RAN area ID) of the RAN area may be assigned for each CU. It should be noted that the RAN area ID is another example of identification information about the base station.

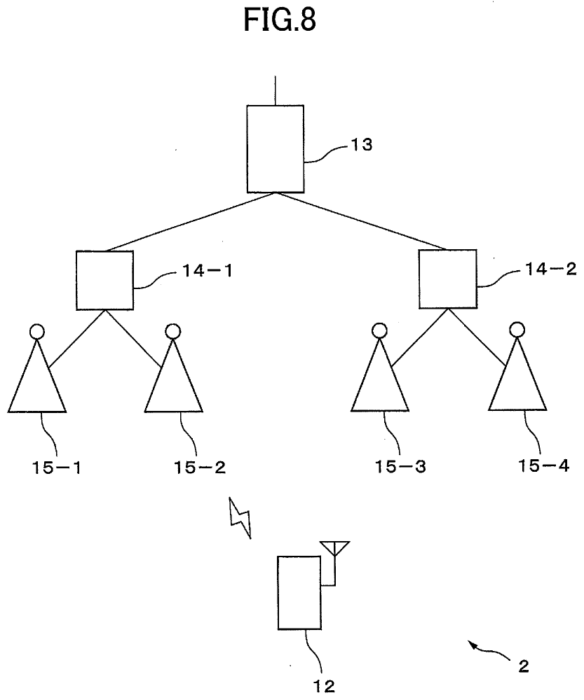

FIG. 8 is a schematic configuration diagram illustrating the wireless communication system according to this variation. The wireless communication system 2 includes two CUs 14-1, 14-2, four DUs 15-1 to 15-4, a wireless terminal 12, and a host node 13. The DU 15-1 and DU 15-2 are connected to the CU 14-1. The DU 15-3 and the DU 15-4 are connected to the CU 14-2. In other words, the CU 14-1, the DU 15-1, and the DU 15-2 form a single base station, and the CU 14-2, the DU 15-3, and the DU 15-4 form another single base station.

It should be noted that the wireless communication system 2 according to this variation differs in the base station configuration as compared to the wireless communication system 1 according to the above-mentioned implementation. Therefore, the configuration of the base station and portions related thereto will be hereinafter explained.

Even in this variation, the number of CUs included in the wireless communication system 2 is not limited to two. The wireless communication system 2 may include more than two CUs. Likewise, the wireless communication system 2 may include two, three, or five or more DUs. The number of DUs connected to one CU is not limited to two. One or three or more DUs may be connected to one CU. Further, the wireless communication system 2 may include multiple wireless terminals 12 or multiple host nodes 13. When the wireless communication system 1 includes multiple host nodes 13, a host node to which the CU 14-1 is connected may be different from a host node to which a CU 14-2 is connected. Furthermore, the wireless terminal 12 may be a mobile terminal, or may be a fixed communication apparatus.

Each of the CU 14-1 and the CU 14-2 and the DUs 15-1 to 15-4 relays communication between the wireless terminal 12 and the host node 13. For this purpose, the CU 14-1 and the CU 14-2 are connected to the host node 13 according to a predetermined communication standard, such as, e.g., S1 interface, stipulated for communication between the host node 13 and the base stations. The CU 14-1 and the CU 14-2 may be connected to each other or to other base stations according to a predetermined communication standard such as, e.g., X2 interface, stipulated for communication between the base stations.

The CU 14-1 and the DU 15-1 and the DU 15-2 are connected via, for example, optical communication connection. Likewise, the CU 14-2 and the DU 15-3 and the DU 15-4 are connected via, for example, optical communication connection. In this variation, a unique RAN area ID is assigned to each of the CU 14-1 and the CU 14-2. In the following, for the sake of convenience, the RAN area ID assigned to the CU 14-1 is a RAN area ID1, and the RAN area ID assigned to the CU 14-2 is a RAN area ID2. The RAN area ID1 assigned to the CU 14-1 is broadcast from the DU 15-1 or the DU 15-2 via a broadcast channel. Likewise, the RAN area ID2 assigned to the CU 14-2 is broadcast from the DU 15-3 or the DU 15-4 via a broadcast channel.

Each of the DUs 15-1 to 15-4 provides one or more cells, and in a case where the wireless terminal 12 is camping on a cell provided by a DU, the DU and the wireless terminal 12 can wirelessly communicate with each other.

For example, when the wireless terminal 12 is camping on a cell that is set by the DU 15-1, the wireless terminal 12 can communicate wirelessly with the CU 14-1 via the DU 15-1. Then, the CU 14-1 executes a procedure for setting a radio connection and procedure for setting a host connection, such as, e.g., random access procedure and context setup, with the wireless terminal 12 capable of wireless communication. Thereafter, the CU 14-1 receives a communication signal addressed to the wireless terminal 12 from the host node 13, and transmits the communication signal as a downlink radio signal via the DU 15-1 to the wireless terminal 12. Also, the CU 14-1 receives an uplink radio signal from the wireless terminal 12 via the DU 15-1, retrieves a communication signal addressed to another communication apparatus (not illustrated) included in that radio signal, and transmits the communication signal to the host node 13.

In a case where the wireless terminal 12 is camping on any one of a cell provided by the DU 15-1 and a cell provided by the DU 15-2, and the CU 14-1 serves as the source base station, the CU 14-1 executes processing for setting resume while the wireless terminal 12 is in the RRC connected state. More specifically, the CU 14-1 attaches a resume ID to the connection setting information about the wireless terminal 12 so that the wireless terminal 12 can use the resume function. Also, the CU 14-1 stores the connection setting information together with the corresponding resume ID. Furthermore, the CU 14-1 notifies the resume ID via the DU 15-1 or the DU 15-2 to the wireless terminal 12 while the wireless terminal 12 continues wireless communication with the CU 14-1, i.e., while the wireless terminal 12 is in the RRC connected state. Likewise, in a case where the wireless terminal 12 is camping on any one of the cells that are set by the CU 14-2, and the CU 14-2 serves as the source base station, the CU 14-2 attaches the resume ID to the connection setting information for the wireless terminal 12. The CU 14-2 stores the connection setting information together with the corresponding resume ID. Furthermore, the CU 14-2 notifies the resume ID to the wireless terminal 12 via the DU 15-3 or the DU 15-4 while the wireless terminal 12 is in RRC Connected state.

Thereafter, in a case where the wireless terminal 12 determines to change the serving cell, the CU 14-1 and the CU 14-2 execute processing for the transfer of the connection setting information.

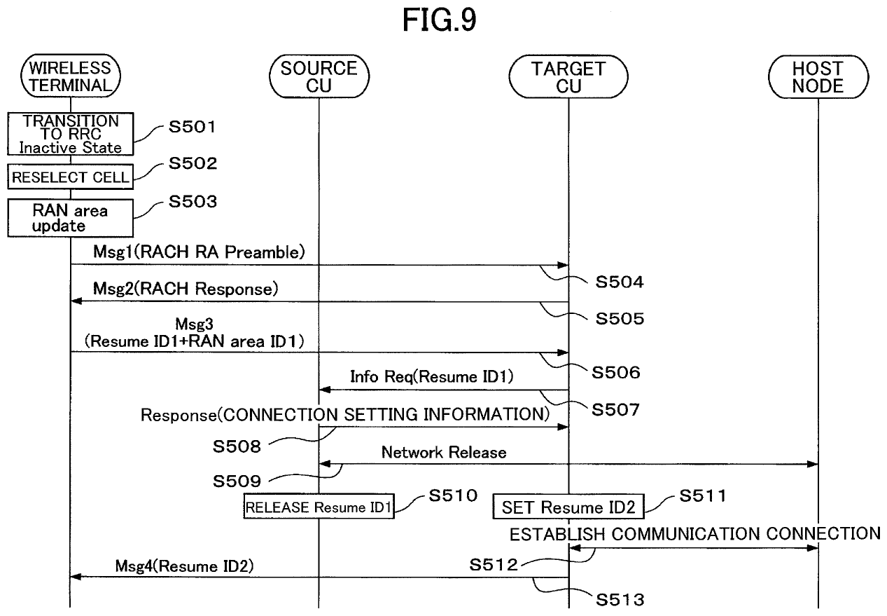

FIG. 9 is a sequence diagram of processing for the transfer of the connection setting information according to this variation. In this example, the CU 14-1 is assumed to be the source CU and the CU 14-2 is assumed to be the target CU. It should be noted that the source CU is an example of source base station, and the target CU is an example of target base station. At a point in time when the wireless terminal 12 changes into the RRC Inactive state, the cell provided by the DU 15-1 is assumed to be the serving cell for the wireless terminal 12. The resume ID which the CU 14-1 assigns to the connection setting information for the wireless terminal 12 is assumed to be the resume ID1, and the resume ID which the CU 14-2 assigns to the connection setting information for the wireless terminal 12 is assumed to be the resume ID2.

After a host connection is set for the wireless terminal 12 while the wireless terminal 12 is in the RRC connected state and the resume ID1 is assigned to the connection setting information, the wireless terminal 12 changes into the RRC Inactive state (step S501).

After the wireless terminal 12 changes into the RRC Inactive state, the wireless terminal 12 measures, with a certain cycle or irregularly, the wireless quality of the old serving cell that is set by the DU 15-1 connected to the CU 14-1 and the wireless quality of a cell that is set by another DU. Then, in a case where the wireless terminal 12 determines that the wireless quality of the cell that is set by the another DU is better than the wireless quality of the old serving cell, the wireless terminal 12 determines to reselect the serving cell (step S502). Then, the wireless terminal 12 changes the serving cell from the cell provided by the DU 15-1 to the cell provided by the another DU (i.e., new serving cell).

When the wireless terminal 12 determines to reselect the serving cell, the wireless terminal 12 determines whether the RAN area ID of the RAN area including the DU providing the new serving cell is different from the RAN area ID of the RAN area including the DU providing the old serving cell. In a case where the RAN area IDs are different before and after the change of the serving cell, the wireless terminal 12 executes RAN area update (step S503). Then, the wireless terminal 12 stores the RAN area ID (in this case, the RAN area ID2) of the RAN area including the DU providing the new serving cell.

After the RAN area update, the wireless terminal 12 executes the random access procedure for the CU 14-2 which is the target CU. More specifically, the wireless terminal 12 transmits a Message 1 including an RA preamble to the CU 14-2 via the DU 15-3 or the DU 15-4 by using a wireless resource for PRACH (step S504). When the CU 14-2 detects the RA preamble, the CU 14-2 transmits an RA response, i.e., response information for the RA preamble, as a Message 2 to the wireless terminal 12 via the DU 15-3 or the DU 15-4 (step S505). The wireless terminal 12 refers to the TA information included in the RA response, and establishes precise synchronization in terms of time with the CU 14-2. Then, the wireless terminal 12 receives a UL scheduling grant from the CU 14-2.

The wireless terminal 12 transmits a Message 3 including a connection request signal, the resume ID1, and the RAN area ID1 of the CU 14-1, i.e., the source CU, to the CU 14-2 via the DU 15-3 or the DU 15-4 by using the resource indicated by the UL scheduling grant (step S506).

When the CU 14-2 receives the Message 3 including the resume ID1 and the RAN area ID1, the CU 14-2 refers to the RAN area ID1, and transmits the resume ID1 to the CU 14-1 to query the connection setting information for the wireless terminal 12 (step S507). It should be noted that in a case where the CU 14-1 and the CU 14-2 are connected with each other via X2 interface, the CU 14-2 may directly transmit the resume ID1 and the RAN area ID1 to the CU 14-1 without going through the host node 13. On the other hand, in a case where the CU 14-1 and the CU 14-2 are connected to different host nodes, the CU 14-2 may transmit the resume ID1 and the RAN area ID1 to the CU 14-1 via the host nodes.

When the CU 14-1 receives the resume ID1 assigned to the wireless terminal 12 and the RAN area ID1 from the CU 14-2, the CU 14-1 replies, to the CU 14-2, with the connection setting information for the wireless terminal 12 stored in association with the resume ID1 (step S508). At this occasion, in a case where the CU 14-1 and the CU 14-2 are connected with each other via X2 interface, the CU 14-1 may directly transmit the connection setting information to the CU 14-2 without going through the host node 13. On the other hand, in a case where the CU 14-1 and the CU 14-2 are connected to different host nodes, the CU 14-1 transmits the connection setting information to the CU 14-2 via the host nodes.

Also, the CU 14-1 executes processing for releasing the host connection that is set for the wireless terminal 12 (step S509). Further, the CU 14-1 also releases (i.e., deletes) the resume ID1 assigned to the wireless terminal 12 (step S510).

On the other hand, when the CU 14-2 receives the connection setting information for the wireless terminal 12 from the CU 14-1, the CU 14-2 assigns the resume ID2 to the wireless terminal 12 (step S511). Then, the CU 14-2 stores the resume ID2 together with the connection setting information for the wireless terminal 12. Also, the CU 14-2 establishes a connection through a communication connection (i.e., a host connection) with the host node 13 for the wireless terminal 12, on the basis of the connection setting information for the wireless terminal 12 (step S512). Then, the CU 14-2 transmits a Message 4 of random access procedure including the resume ID2 to the wireless terminal 12 via the DU 15-3 or the DU 15-4 (step S513). The wireless terminal 12 stores the received resume ID2. Then, the CU 14-1, the CU 14-2, and the wireless terminal 12 finish the transfer processing of the connection setting information.

Also in this variation, in the transfer processing of the connection setting information, the wireless terminal may transmit the RAN area ID1 and the resume ID1 to the target CU after the random access procedure is finished. Also, the target CU may notify the resume ID2 to the wireless terminal after the random access procedure is finished.

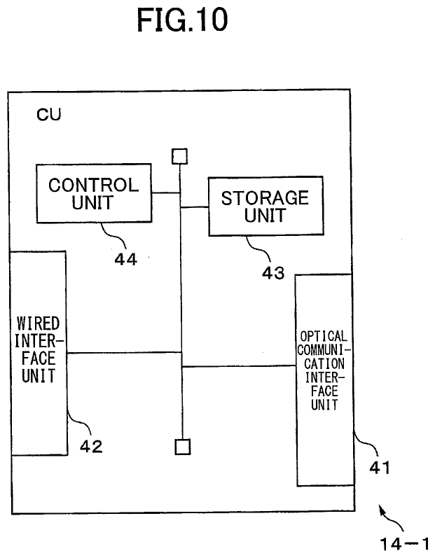

FIG. 10 is a schematic configuration diagram illustrating the CU 14-1. It should be noted that the configuration and the function of the CU 14-1 may be the same as or similar to the configuration and the function of the CU 14-2, and accordingly, the CU 14-1 will be hereinafter explained.

As illustrated in FIG. 10, the CU 14-1 includes an optical communication interface unit 41, a wired interface unit 42, a storage unit 43, and a control unit 44. The storage unit 43 and the control unit 44 are formed as separate connections. Alternatively, each of these units may be implemented on the CU 14-1 as one or more integrated connections in which connections corresponding to the respective units are integrated.

The optical communication interface unit 41 includes a communication interface connection with which the CU 14-1 connects to the DU 15-1 and the DU 15-2 via optical communication connection. In transmission, the optical communication interface unit 41 converts, into an optical signal, various control information (for example, a RAN area ID) to be broadcast via the DU 15-1 or the DU 15-2 or a downlink signal for the wireless terminal 12 received from the control unit 44, and transmits the optical signal to the DU 15-1 or the DU 15-2. In reception, the optical communication interface unit 41 receives, from the DU 15-1 or the DU 15-2, an optical signal including an uplink signal transmitted from the wireless terminal 12, converts the optical signal into an electric signal, and passes the electric signal to the control unit 44.

The wired interface unit 42 includes a communication interface connection with which the CU 14-1 connects to the host node 13 and another base station or another CU. In reception, the wired interface unit 42 analyzes a signal received from the host node 13 according to S1 interface, and extracts a downlink signal, a control signal, and the like included in that signal. Also, the wired interface unit 42 analyzes the signal received from another base station or another CU according to X2 interface, and extracts a control signal, connection setting information, the RAN area ID, or the like included in that signal. Then, the wired interface unit 42 passes the extracted downlink signal, the control signal, and the like to the control unit

In transmission, the wired interface unit 42 converts an uplink signal received from the control unit 44 into a signal in a format according to S1 interface, and outputs the converted signal to the host node 13. Also, the wired interface unit 42 converts a control signal, connection setting information, or RAN area ID, which is to be transmitted to another base station or another CU, into a format according to X2 interface. Then, the wired interface unit 42 outputs (or transmits or notifies) the control signal or the like to another base station or another CU.

The storage unit 43 has, for example, a rewritable nonvolatile semiconductor memory or a volatile semiconductor memory. The storage unit 43 stores various information for communicating with the wireless terminal 12, various information to be transmitted or received by the CU 14-1, and various programs operating on the CU 14-1. In the present embodiment, the storage unit 43 stores the connection setting information and the resume ID for the wireless terminal connected to the CU 14-1. In addition, the storage unit 43 stores the RAN area ID that is set for the CU 14-1.

The control unit 44 has, for example, one or more processors and their peripheral connections. The control unit 44 executes wireless resource control among the processing for communicating with the wireless terminal 12. Furthermore, the control unit 44 executes processing for some of upper layers among a physical (PHY) layer, a Media Access Control (MAC) layer, a Radio Link Control (RLC) layer, and a Packet Data Convergence Protocol (PDCP) layer. For example, the control unit 44 executes processing for all or a part of the MAC layer (for example, encryption, etc.), the RLC layer, and the PDCP layer. Alternatively, the control unit 44 may execute processing for the RLC layer and the PDCP layer, or may execute processing for the PDCP layer.

Also, the control unit 44 attaches a resume ID to connection setting information obtained by performing connection setting processing for the wireless terminal 12.

Furthermore, in a case where the CU 14-1 serves as a target CU for the wireless terminal 12 and takes over the connection setting information from another base station (for example, the CU 14-2), the CU 14-1 executes processing for the target CU in the transfer processing of the connection setting information. At this occasion, the control unit 44 may operate according to the operation flowchart illustrated in FIG. 4. In this case, however, in step S201, the control unit 44 may determine whether the Message 3 includes the RAN area ID1 or not, instead of determining whether the Message 3 includes the identification information about the source base station. Also, the control unit 44 may identify the source CU by referring to the RAN area ID1 in step S203.

Alternatively, in a case where the CU 14-1 serves as a source CU for the wireless terminal 12 and transfers the connection setting information to another base station (for example, the CU 14-2), the CU 14-1 executes processing for the source CU in the transfer processing of the connection setting information. At this occasion, the control unit 44 may operate according to the operation flowchart illustrated in FIG. 5.

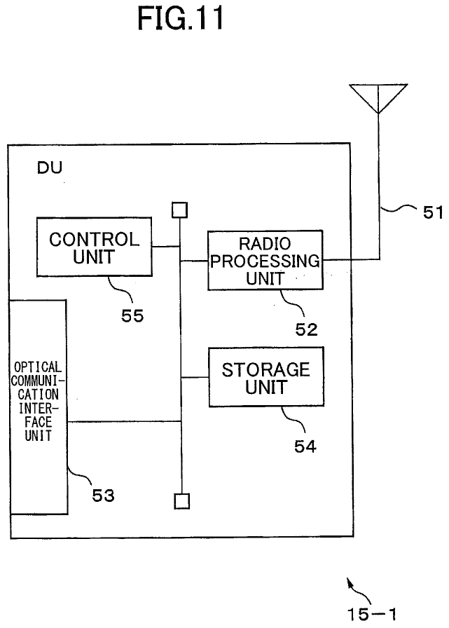

FIG. 11 is a schematic configuration diagram illustrating the DU 15-1. It should be noted that the configurations and the functions of the DU 15-1 to the DU 15-4 may be the same as or similar to each other, and accordingly, the DU 15-1 will be hereinafter explained. The DU 15-1 includes an antenna 51, a radio processing unit 52, an optical communication interface unit 53, a storage unit 54, and a control unit 55. The radio processing unit 52, the storage unit 54, and the control unit 55 are formed as separate connections. Alternatively, each of these units may be implemented on the DU 15-1 as one or more integrated connections in which connections corresponding to the respective units are integrated.

The antenna 51 and the radio processing unit 52 have the same configurations and functions as or similar configurations and functions to those of the antenna 21 and the radio processing unit 22 in the base station 11 according to the above embodiment illustrated in FIG. 3. Therefore, as to the details of the antenna 51 and the radio processing unit 52, the above explanation about the antenna 21 and the radio processing unit 22 are to be referred to.

The optical communication interface unit 53 includes a communication interface connection with which the DU 15-1 connects to the CU 14-1 via optical communication connection. In reception, the optical communication interface unit 53 converts, into an electric signal, an optical signal including various control information (for example, a RAN area ID) to be broadcast via the DU 15-1 or a downlink signal for the wireless terminal 12 received from the optical communication connection, and passes the electric signal to the control unit 55. In transmission, the optical communication interface unit 53 receives, from the control unit 55, an uplink signal transmitted from the wireless terminal 12, converts the uplink signal into an optical signal, and transmits the optical signal to the CU 14-1.

The storage unit 54 has, for example, a rewritable nonvolatile semiconductor memory or a volatile semiconductor memory. The storage unit 54 stores various information for communicating with the wireless terminal 12 (for example, identification information about cells provided by the DU 15-1), various information to be transmitted or received by the DU 15-1, and various programs operating on the DU 15-1.

The control unit 55 has, for example, one or more processors and their peripheral connections. Furthermore, the control unit 55 executes processing for some of layers among the PHY layer, the MAC layer, the RLC layer, and the PDCP layer, other than the processing of layers executed by the control unit 44 of the CU 14-1. For example, in a case where the control unit 44 executes processing for the MAC layer, the RLC layer, and the PDCP layer, the control unit 55 executes processing for the PHY layer. Alternatively, in a case where the control unit 44 executes processing for a part of the MAC layer, the RLC layer, and the PDCP layer, the control unit 55 executes processing for the PHY layer and the remaining part of the MAC layer (for example, retransmission control). Still alternatively, in a case where the control unit 44 executes processing for the RLC layer and the PDCP layer, the control unit 55 executes processing for the PHY layer and the MAC layer. Still alternatively, in a case where the control unit 44 executes processing for the PDCP layer, the control unit 55 executes processing for the PHY layer, the MAC layer, and the RLC layer.

The wireless terminal 12 according to this variation has a configuration similar to that of the wireless terminal 12 according to the above embodiment illustrated in FIG. 6. However, in the wireless terminal 12 according to this variation, some of the procedures for the transfer processing of the connection setting information are different from the procedure illustrated in FIG. 7.

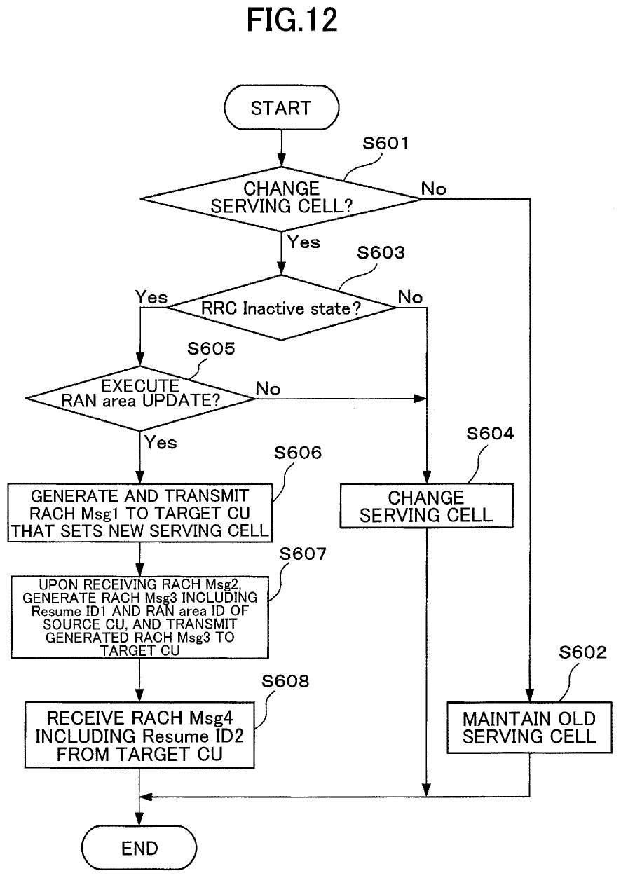

FIG. 12 is an operation flowchart performed by the wireless terminal 12 in the transfer processing of the connection setting information according to this variation. The control unit 34 of the wireless terminal 12 illustrated in FIG. 6 executes the transfer processing of the connection setting information according to this operation flowchart.

The control unit 34 determines whether to change the serving cell by comparing the quality of radio signal of the old serving cell and the quality of radio signal of another cell in which the wireless terminal 12 is located (step S601). In a case where the control unit 34 determines not to change the serving cell (step S601-Yes), the control unit 34 maintains the old serving cell (step S602).

On the other hand, in a case where the control unit 34 determines to change the serving cell (step S601-Yes), the control unit 34 determines whether the wireless terminal 12 is in the RRC inactive state (step S603). In a case where the wireless terminal 12 is not in the RRC Inactive state (step S603-No), the control unit 34 changes the serving cell to the another cell of which the quality of radio signal is better than the quality of radio signal of the old serving cell (step S604).

On the other hand, in a case where the wireless terminal 12 is in the RRC Inactive state (step S603-Yes), the control unit 34 determines whether to perform RAN area update by comparing the RAN area ID of the RAN area including the serving cell before and after the change (step S605). In a case where the control unit 34 determines not to perform the RAN area update (step S605-No), the RAN area including the new serving cell is the same as the RAN area including the old serving cell. In other words, even though the serving cell is changed, the wireless terminal 12 communicates with the core network via the same CU. Therefore, the control unit 34 executes processing in step S604.

On the other hand, when the control unit 34 determines to perform the RAN area update (step S605-Yes), the control unit 34 generates a Message 1 of random access procedure including an RA preamble. Then, the control unit 34 refers to the RAN area ID and the cell ID broadcast by the new serving cell, and transmits the Message 1 through PRACH via the radio processing unit 32 and the antenna 31 to the target CU connected to the DU providing the new serving cell (step S606).

Thereafter, when the control unit 34 receives a Message 2 of random access procedure via the antenna 31 and the radio processing unit 32 from the target CU, the control unit 34 generates a Message 3 of random access procedure including the resume ID1 and the RAN area ID. Then, the control unit 34 transmits the Message 3 to the target CU via the radio processing unit 32 and the antenna 31 (step S607).

Thereafter, when the control unit 34 receives, from the target CU, a Message 4 of random access procedure via the antenna 31 and the radio processing unit 32, the control unit 34 retrieves the resume ID2 included in the Message 4. Then, the control unit 34 saves the resume ID2 to the storage unit 33 (step S608).

After steps S602, S604 or S608, the control unit 34 finishes the operation of the wireless terminal 12 in the transfer processing of the connection setting information.

In the wireless communication system according to this variation, in a case where the wireless terminal in the RRC Inactive state changes the serving cell, the wireless terminal determines whether the RAN area including the new serving cell is the same as the RAN area including the old serving cell. Then, in a case where the RAN area including the serving cell changes before and after the change of the serving cell, the wireless terminal transmits, to the target CU connected to the DU providing the new serving cell, the RAN area ID and the resume ID of the source CU connected to the DU providing the old serving cell. The target CU refers to the received RAN area ID, and transmits the resume ID to the source CU to query the connection setting information corresponding to the resume ID. Therefore, even in a case where the RAN area including the serving cell is also changed before and after the change of the serving cell, the wireless communication system according to this variation can transfer the connection setting information maintained for the wireless terminal to the target CU connected to the DU providing the new serving cell.

In addition, according to another variation, in the wireless communication system 2 illustrated in FIG. 8, the RAN area IDs may be individually transmitted to the wireless terminal via dedicated channels. In this case, even when the wireless terminal 12 changes the serving cell, the wireless terminal 12 cannot determine whether the RAN area including the DU providing the serving cell is changed or not before and after the change. Therefore, in this variation, the target CU connected to the DU providing the new serving cell refers to the RAN area ID received from the wireless terminal 12 to determine whether to use the transferred connection setting information or not.

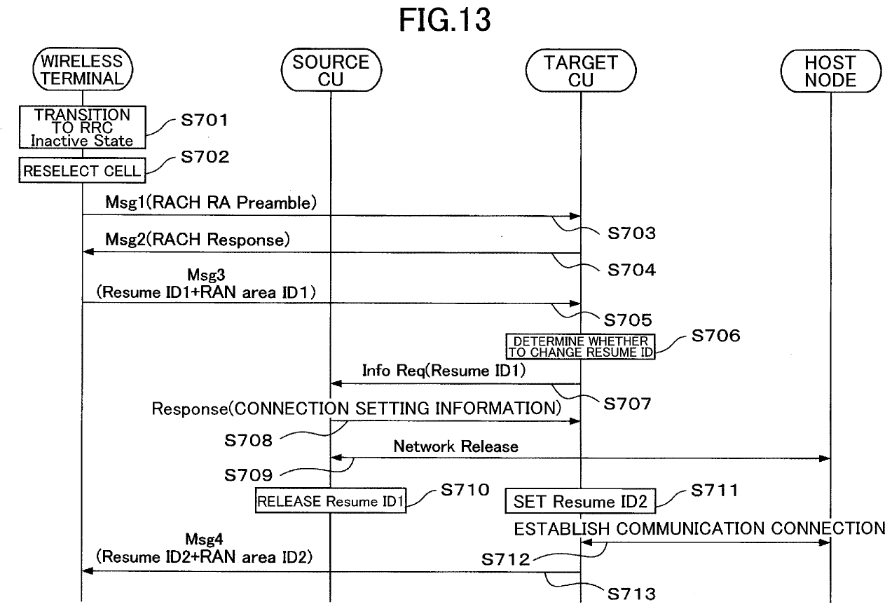

FIG. 13 is a sequence diagram of processing for transfer of the connection setting information according to this variation. In this example, the CU 14-1 is assumed to be a source CU (source base station). The target CU (target base station) is assumed to be any one of the CU 14-1 and the CU 14-2. At a point in time when the wireless terminal 12 changes into the RRC Inactive state, the cell provided by the DU 15-1 is assumed to be the serving cell for the wireless terminal 12. The resume ID which the CU 14-1 assigns to the connection setting information for the wireless terminal 12 is assumed to be the resume ID1, and the resume ID which the CU 14-2 assigns to the connection setting information for the wireless terminal 12 is assumed to be the resume ID2.

After a host connection is set for the wireless terminal 12 while the wireless terminal 12 is in the RRC connected state and the resume ID1 is assigned to the connection setting information for the wireless terminal 12, the wireless terminal 12 changes into the RRC Inactive state (step S701).

After the wireless terminal 12 changes into the RRC Inactive state, the wireless terminal 12 measures, with a certain cycle or irregularly, the wireless quality of the old serving cell that is set by the DU 15-1 connected to the CU 14-1 and the wireless quality of a cell that is set by another DU. Then, in a case where the wireless terminal 12 determines that the wireless quality of the cell that is set by the another DU is better than the wireless quality of the old serving cell, the wireless terminal 12 determines to reselect the serving cell (step S702). Then, the wireless terminal 12 changes the serving cell from the cell provided by the DU 15-1 to the cell provided by the another DU (i.e., new serving cell).

After the reselection of the serving cell, the wireless terminal 12 executes random access procedure for the target CU. More specifically, the wireless terminal 12 transmits, via PRACH, a Message 1 including an RA preamble to the target CU connected to the DU providing the new serving cell (step S703). When the target CU detects the RA preamble, the target CU transmits an RA response, i.e., response information for the RA preamble, as a Message 2 to the wireless terminal 12 via the DU providing the new serving cell (step S704). The wireless terminal 12 refers to the TA information included in the RA response, and establishes precise synchronization in terms of time with the target CU. Then, the wireless terminal 12 receives a UL scheduling grant from the target CU.

The wireless terminal 12 transmits a Message 3 including a connection request signal, the resume ID1, and the RAN area ID1 of the CU 14-1, i.e., the source CU, to the target CU via the DU providing the new serving cell by using the resource indicated by the UL scheduling grant (step S705).

When the target CU receives the Message 3 including the resume ID1 and the RAN area ID1, the target CU determines whether to change the resume ID by checking whether the received RAN area ID1 matches the RAN area ID assigned to the target CU (step S706). In a case where the received RAN area ID1 matches the RAN area ID assigned to the target CU, i.e., in a case where the target CU connected to the DU providing the new serving cell is the CU 14-1, the target CU does not change the resume ID. In other words, since the target CU is the same as the source CU, transfer of the connection setting information is not performed.

On the other hand, in a case where the received RAN area ID1 is different from the RAN area ID assigned to the target CU, the target CU determines to change the resume ID. More specifically, since the target CU is different from the source CU, the transfer of the connection setting information from the source CU to the target CU is performed. Therefore, the target CU and the source CU execute the processing in step S707 to step S712. It should be noted that the processing in step S707 to step S712 is the same as the processing in step S507 to step S512 in the sequence illustrated in FIG. 9. Accordingly, the explanation about the processing in step S707 to step S712 is omitted here.

After a communication connection between the target CU and the core network is established in step S712, the target CU generates a Message 4 of random access procedure including the resume ID2 and the RAN area ID2 assigned to the target CU. Then, the target CU transmits the Message 4 to the wireless terminal 12 via the DU providing the new serving cell (step S713). The wireless terminal 12 stores the received resume ID2. Then, the source CU, the target CU, and the wireless terminal 12 finish the transfer processing of the connection setting information.

Also in this variation, in the transfer processing of the connection setting information, the wireless terminal may transmit the RAN area ID1 and the resume ID1 to the target CU after the random access procedure is finished. Also, the target CU may notify the resume ID2 to the wireless terminal after the random access procedure is finished. In this example, however, in a case where the target CU is the same as the source CU, the resume ID2 is not transmitted from the target CU to the wireless terminal. Therefore, in a case where, for example, the wireless terminal does not receive the resume ID2 even after a certain period of time passes since the wireless terminal transmitted the RAN area ID1 and the resume ID1 to the target CU, the wireless terminal may determine that a transfer of the connection setting information is not performed.

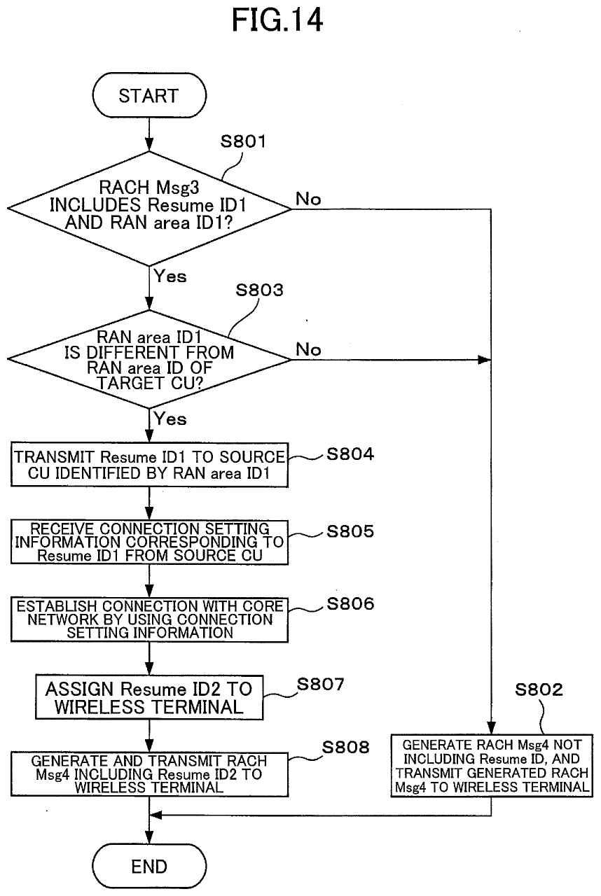

FIG. 14 is an operation flowchart performed by the target CU in the transfer processing of the connection setting information according to this variation.

The control unit 44 of the target CU determines whether the Message 3 of the random access procedure received from the wireless terminal 12 includes the resume ID1 assigned to the wireless terminal 12 by the source CU and the RAN area ID1 assigned to the source CU (step S801). In a case where the resume ID1 and the RAN area ID1 are not included (step S801-No), the control unit 44 continues the processing of the random access procedure for the wireless terminal 12. Then, the control unit 44 generates an RACH Message 4 not including any resume ID, and transmits the generated Message 4 to the wireless terminal 12 via the DU providing the new serving cell (step S802).

On the other hand, in a case where the resume ID1 and the RAN area ID1 are included (step S801-Yes), the control unit 44 determines whether the RAN area ID1 is different from the RAN area ID assigned to the target CU (step S803). In a case where the RAN area ID1 is not different from (i.e., matches) the RAN area ID assigned to the target CU (step S803-No), the source CU is the same as the target CU, and accordingly, transfer of the connection setting information for the wireless terminal 12 is not performed. Therefore, the control unit 44 executes the processing in step S802.

On the other hand, in a case where the RAN area ID1 is different from the RAN area ID assigned to the target CU (step S803-Yes), the target CU is different from the source CU. Accordingly, the control unit 44 executes processing in step S804 to step S808. It should be noted that the processing in step S804 to step S808 is basically the same as the processing in step S203 to step S207 in the operation flowchart illustrated in FIG. 4. Therefore, the detailed explanation about the processing in step S804 to step S808 will be omitted. However, in step S804, the RAN area ID1 is referred to as the identification information about the source base station.

After step S802 or step S808, the control unit 44 finishes the operation of the target CU in relation to the transfer processing of the connection setting information.

It should be noted that, in step S802, the control unit 44 may generate a Message 4 including the resume ID1, and transmit the generated Message 4 to the wireless terminal 12.

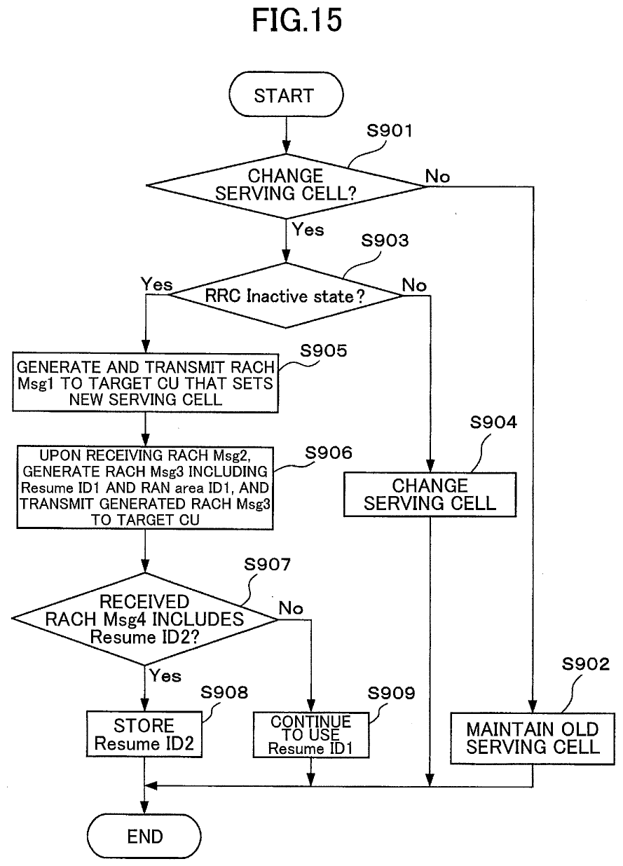

FIG. 15 is an operation flowchart performed by the wireless terminal in the transfer processing of the connection setting information according to this variation.

The control unit 34 determines whether to change the serving cell by comparing the quality of radio signal of the old serving cell and the quality of radio signal of another cell in which the wireless terminal 12 is located (step S901). In a case where the control unit 34 determines not to change the serving cell (step S901-No), the control unit 34 maintains the old serving cell (step S902).

On the other hand, in a case where the control unit 34 determines to change the serving cell (step S901-Yes), the control unit 34 determines whether the wireless terminal 12 is in the RRC inactive state (step S903). In a case where the wireless terminal 12 is not in the RRC Inactive state (step S903-No), the control unit 34 changes the serving cell to the another cell of which the quality of radio signal is better than the quality of radio signal of the old serving cell (step S904).

On the other hand, in a case where the wireless terminal 12 is in the RRC Inactive state (step S903-Yes), the control unit 34 generates a Message 1 of the random access procedure including an RA preamble. Then, the control unit 34 refers to the broadcast information transmitted from the new serving cell, and transmits a Message 1 through PRACH to the target CU, which is connected to the DU providing the new serving cell, via the radio processing unit 32 and the antenna 31 (step S905).

Thereafter, when the control unit 34 receives a Message 2 of random access procedure from the target CU via the antenna 31 and the radio processing unit 32, the control unit 34 generates a Message 3 of random access procedure including the resume ID1 and the RAN area ID1. Then, the control unit 34 transmits the Message 3 to the target CU via the radio processing unit 32 and the antenna 31 (step S906).

Thereafter, when the control unit 34 receives a Message 4 of random access procedure from the target CU via the antenna 31 and the radio processing unit 32, the control unit 34 determines whether the received Message 4 includes a resume ID2 (step S907). In a case where the received Message 4 includes a resume ID2 (step S907-Yes), the control unit 34 retrieves the resume ID2 from the Message 4. Then, the control unit 34 stores the resume ID2 into the storage unit 33 (step S908). The control unit 34 uses the resume ID2 when communication is resumed later. On the other hand, in a case where the received Message 4 does not include a resume ID2 (step S907-No), the control unit 34 continues to use the resume ID1 (step S909).

After steps S902, S904, S908 or S909, the control unit 34 finishes the operation of the wireless terminal 12 in the transfer processing of the connection setting information.

It should be noted that even in a case where the received Message 4 includes the resume ID1 in step S907, the control unit 34 may execute the processing in step S909.

According to this variation, even in a case where the identification information about the RAN areas is individually transmitted to the wireless terminal, the wireless communication system can transfer the connection setting information from the source CU to the target CU as necessary in a case where the wireless terminal changes the serving cell. Therefore, even in a case where the wireless terminal changes the serving cell while the wireless terminal is in RRC Inactive state, the wireless communication system can maintain the communication connection between the base station and the core network for the wireless terminal.

It should be noted that the wireless communication system 2 illustrated in FIG. 8 may include a base station which is not separated into CU and DU illustrated in FIG. 1 (hereinafter simply referred to as a base station). In this case, in a case where the base station is a source base station in the transfer processing of the connection setting information, the wireless terminal may transmit, to the target CU, the identification information about the base station such as, e.g., a cell ID, together with the resume ID that is set by the base station. Then, the target CU may query the connection setting information for the wireless terminal by transmitting the resume ID1 to the source base station identified by the received identification information about the source base station. In a case where the base station is a target base station in the transfer processing of the connection setting information, the wireless terminal may transmit, to the target base station, the resume ID1 that is set by the source CU and the RAN area ID1 assigned to the source CU. Then, the target base station may query the connection setting information for the wireless terminal by transmitting the resume ID1 to the source CU identified by the RAN area ID1.

In the embodiment or the variations explained above, in a case where the base station providing the new serving cell does not support the RRC Inactive state, the base station providing the new serving cell may release the communication connection between the base station and the core network for the wireless terminal. Then, the base station may notify the wireless terminal to that effect, and the wireless terminal may change to the RRC Idle state upon receiving the notification.

In the embodiment or the variations explained above, the wireless terminal may determine whether to change the serving cell on the basis of information other than the quality of the received radio signal of each cell.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. A wireless terminal comprising:
a radio transceiver configured to transmit a radio signal to any one of a plurality of base stations providing cells, or to receive a radio signal from any one of the plurality of base stations;
a storage configured to store first connection identification information and base station identification information, the first connection identification information identifying connection setting information, in a first state, about a communication connection between a core network and a first base station of the plurality of base stations used by the wireless terminal to communicate via the first base station, the base station identification information identifying the first base station, the first base station providing a first cell adopted as a serving cell which the wireless terminal camps on for the radio signal, and the first state being a state in which a radio connection between the wireless terminal and the first base station is disconnected but the communication connection is maintained; and
a controller configured to perform control to transmit the first connection identification information and the base station identification information via the radio transceiver to a second base station providing a second cell when changing the serving cell or a central unit while the wireless terminal is in the first state, the central unit processing the radio signal, and perform control to store, in the storage, second connection identification information for identifying the connection setting information received from the second base station.

2. The wireless terminal according to claim 1, wherein the first base station comprises:
a distributed unit configured to transmit or receive the radio signal,
wherein the central unit is provided in the first base station and connected to the distributed unit,
wherein the radio transceiver transmits, to the second base station, identification information about the central unit of the first base station as the base station identification information.

3. The wireless terminal according to claim 1, wherein when changing the serving cell or the central unit, the controller executes processing for establishing communication with the second base station according to random access procedure, and the radio transceiver transmits the first connection identification information and the base station identification information to the second base station in the random access procedure.

4. A base station providing a cell, comprising:
a radio transceiver configured to transmit a radio signal to a wireless terminal, or to receive a radio signal from the wireless terminal;
a communication interface configured to connect to a host node or another base station; and
a controller configured to perform:
receiving base station identification information and first connection identification information from the wireless terminal via the radio transceiver, the base station identification information identifying another base station, the first connection identification information identifying connection setting information, in a first state, about a communication connection between a core network and the another base station which the wireless terminal uses to communicate via the another base station, and the first state being a state in which a radio connection between the wireless terminal and the another base station is disconnected but the communication connection is maintained;
transmitting the first connection identification information via the communication interface to the another base station identified by the base station identification information;
receiving the connection setting information corresponding to the first connection identification information via the communication interface from the another base station; and
associating the connection setting information with second connection identification information, and transmitting the second connection identification information via the radio transceiver to the wireless terminal.

5. The base station according to claim 4, wherein upon receiving the connection setting information, the controller uses the connection setting information to establish a communication connection between the base station and the core network for the wireless terminal.

6. The base station according to claim 4, further comprising:
a storage configured to further store second base station identification information for identifying the base station,
wherein the controller is configured to, when determining that the base station identification information received from the wireless terminal is different from the second base station identification information, transmit the first connection identification information via the communication interface to the another base station.

7. The according to claim 4, wherein the controller is configured to receive the base station identification information and the first connection identification information in a random access procedure between the wireless terminal and the base station, and notify the second connection identification information to the wireless terminal in the random access procedure.

8. A base station providing a cell, comprising:
a communication interface configured to connect to a host node or another base station;
a storage configured to store connection setting information in association with first connection identification information, the connection setting information including information, in a first state, about a communication connection between a core network and the base station used by the wireless terminal to communicate via the base station, and the first state being a state in which a radio connection between the wireless terminal and the base station is disconnected but the communication connection is maintained; and
a controller configured to, upon receiving the first connection identification information via the communication interface unit from another base station, transmit the connection setting information via the communication interface unit to the another base station.

9. The base station according to claim 8, wherein the controller is configured to, upon transmitting the connection setting information to the another base station, release the communication connection maintained for the wireless terminal and delete the first connection identification information from the storage unit.
